(19) United States
(12) Patent Application Publication
(10) Pub. No.: US 2026/0182532 A1
(43) Pub. Date: Jul. 2, 2026

(54) ASSEMBLY COMPRISING A MILKING DEVICE AND A MEASURING DEVICE FOR MEASURING A MASS FLOW OF MILKED MILK

(71) Applicant: GEA Farm Technologies GmbH, Bönen (DE)

(72) Inventor: Otto Krone, Ibbenbüren (DE)

(21) Appl. No.: 19/129,519

(22) PCT Filed: Nov. 3, 2023
(86) PCT No.: PCT/EP2023/080734

§ 371 Date: May 13, 2025

(30) Foreign Application Priority Data
Nov. 18, 2022 (DE) 10 2022 130 620.8

(51) Int. Cl. A01J 5/01; G01F 1/64; G01F 15/14

(52) U.S. Cl. CPC A01J 5/01; G01F 1/64; G01F 15/14

(57) ABSTRACT

The invention relates to an assembly comprising a milking device and a measuring device for measuring a mass flow of milked milk. The measuring device has a housing comprising: an inlet which is connected to the milking device; an outlet; and a channel that connects the inlet and the outlet. The channel has, in the direction of the outlet, a first portion, a transition region, and a second portion. The first portion, the transition region and the second portion have a common base which extends uniformly down to the outlet. In the transition region, the flow cross-section of the first portion is reduced towards the second portion. A measuring device comprises a first electrode and a second electrode which are positioned at a distance from one another. At least one of the electrodes is positioned inside the second portion and, with respect to the direction of flow, is positioned downstream of and at a distance from the transition region. A voltage source is connected to two regions of the first electrode that are remote from one another. A detection device is electrically connected to the first electrode and the second electrode.

The invention relates to an assembly comprising a milking device and a measuring device for measuring a mass flow of milked milk.

The result of a milk measurement during a milking operation represents a variable that is a relevant parameter on a dairy farm. Firstly, the knowledge of a current milk flow is relevant to the control of the milking process in order, for example, to establish the transition from a stimulation phase to a main milking phase, or to establish the removal point, normally the end of the milking operation, or to adapt other parameters during the milking operation.

The result of the milk quantity measurement is also important for assessing the output capacity of the individual animals to be milked. The animals to be milked can be, for example, cows, sheep, goats, buffaloes, llamas, camels, dromedaries. The enumeration of the individual types of animal is not exhaustive. If reference is made below to milking cows, this reference is by way of example.

A fundamental problem in a milk quantity measurement during a milking operation is that milk is transported drop by drop through a milk tube by the milking operation as such. As a result, determining the current milk flow is difficult.

Furthermore, there is the problem that milk is a foaming fluid. As a result, mention is also made of a multi-phase liquid, namely of a liquid phase and of a foam phase.

These fundamental problems have already been recognized. There are numerous different methods, devices and measuring apparatuses which have been proposed for the measurement of a mass flow of milked milk.

WO 2006/037589 A1 has disclosed a measuring device for measuring a mass flow of milked milk. This measuring device is based on the basic idea that the foam content is mixed with the liquid content of the milk. In order to achieve this, the housing of the measuring device is formed in such a way that the inlet leads substantially tangentially into the interior of the housing. An axis of a portion of the housing is inclined by at least 30° to the vertical upstream of the sensor for determining the mass flow. A portion of the housing upstream of the sensor is at least substantially rotationally symmetrical in the interior. As a result of the configuration of the housing, the mixing of the foam that is present into the liquid phase of the milk is achieved. This produces a liquid, milk, which has substantially no standing foam that is located on the liquid level.

Starting from this point, the present invention is based on the object of improving the measurement accuracy still further.

This object is achieved by an assembly comprising a milking device and a measuring device for measuring a mass flow of milked milk having the features of claim 1. Advantageous developments and refinements of the assembly are the subject matter of the independent claims.

The assembly according to the invention comprises a milking device and a measuring device for measuring a mass flow of milked milk. The measuring device has a housing with an inlet that is connected to the milking device, an outlet and a channel that connects the inlet and the outlet. In the direction of the outlet, the channel has a first portion, a transition region and a second portion. The first portion, the transition region and the second portion have a common base which falls monotonously toward the outlet. This includes, based on a vertical, the inlet being located at a higher level than the outlet. The channel can also have a portion which extends substantially horizontally.

In the transition region, the flow cross section of the first portion is reduced toward the second portion.

The measuring apparatus of the assembly according to the invention comprises a first and a second electrode arranged spaced apart from one another. At least one of the electrodes is arranged within the second portion and, seen in the flow direction, downstream of and at a distance from the transition region. This includes the at least one electrode being arranged within the second portion downstream of the transition region. It is arranged at a distance from the transition region. The second portion has a region which is formed from an electrically non-conductive material. Seen in the flow direction of the milk, the region is formed upstream of the at least one electrode. This configuration avoids a foam that accumulates in the transition region coming into contact with the at least one electrode which is arranged in the second portion. In this way, an improvement in the measurement accuracy is achieved.

The measuring apparatus has a voltage source which is connected to the first electrode by two regions that are remote from one another.

Furthermore, the measuring apparatus comprises a detection apparatus which is electrically connected to the first and the second electrode. The detection apparatus is suitable for and intended to measure a voltage potential between the first electrode and the second electrode.

If milk with a foam phase flows into the housing, then the foam content is mixed with the liquid content of the milk. The housing is appropriately structured.

In order to achieve a higher measurement accuracy, and therefore also to achieve a higher reliability and independence of mixing of the foam content with the liquid content of the milk, the housing and the measuring apparatus are designed such that at least one of the electrodes is arranged inside the second portion and, seen in the flow direction, downstream of and at a distance from the transition region. In this way, the influence of a “standing” foam on the flowing milk in the region of the measuring apparatus is reduced. This is advantageous in particular when the flowing quantity of milk is low. A low milk flow can occur in particular at the start and/or toward the end of a milking operation.

By means of this configuration of the assembly according to the invention, a higher accuracy of the measurement of a mass flow of milked milk is achieved.

The assembly according to the invention has a measuring device with a housing, wherein the housing has a first portion, a transition region and a second portion, which have a common base which falls monotonously toward the outlet. This achieves the situation in which the milked milk flows through the housing in a pressure-free manner. Pressure-free in the sense of the invention means that the flowing operation takes place as a result of the prevailing gravity.

As a result of the configuration according to the invention of the assembly, a high measurement accuracy is achieved even when there is a low milk flow. In this way, the possibility is also provided, for example in the case of a cow, of carrying out a quarter-udder milk measurement. Thus, for each quarter-udder of a cow, the quantity of milk milked from each quarter-udder can be determined. This also has the advantage that during a milking operation in which a milking apparatus which is suitable to be operated individually for each quarter-udder is provided, individual quarter-udders do not continue to be milked in the event of a reduction in the quantity of milk.

To reduce accumulations of foam, in an advantageous refinement of the invention, it is proposed that the flow cross section of the first portion is reduced continuously toward the second portion. In this way, a disruption to the flow in the region of the transition is to be avoided. If it entirely fills the free volume above the liquid phase in the housing, foam that is produced and does not flow out of the housing can exert a certain pressure on the liquid phase and thus accelerate the flow of the liquid phase. This leads to a change in the flow velocity, which can be avoided by the advantageous configuration of the housing.

The housing as such is preferably entirely produced from an electrically non-conductive material. In particular, the housing can be produced from a non-conductive plastic. It is proposed that the second portion, that is to say the portion in which the electrodes are located, is detachably connected to the further constituent part or parts of the housing. The electrode is preferably an integral constituent part of the second portion.

In particular, it is proposed that the electrode has an L-shaped or U-shaped cross section. If the electrode has an L-shaped portion, then one leg of the electrode is provided with openings, so that to produce the second portion, the electrode can be introduced into a mold which is then filled with a plastic. The plastic penetrates the openings in the leg of the L-shaped electrode, so that secure retention of the electrode is achieved. In a corresponding way, the procedure can also be the same during the production of the second portion. Here, in the case of an electrode which has a U-shape in cross section, the two legs of the U-shaped electrode can have corresponding openings. It goes without saying that an end portion of an electrode projects out of the housing. This end portion of the electrode forms a connection possibility.

In order to increase the accuracy of the milk quantity measurement still further, it is proposed that the distance between the electrodes, seen from the base, increases in a vertical direction, which corresponds to a V-shaped opening between the electrodes, through which the milk flows.

Further advantageous refinements of the invention are explained using the exemplary embodiment illustrated in the drawing, without giving rise to any restriction to this specific exemplary embodiment. In the drawing:

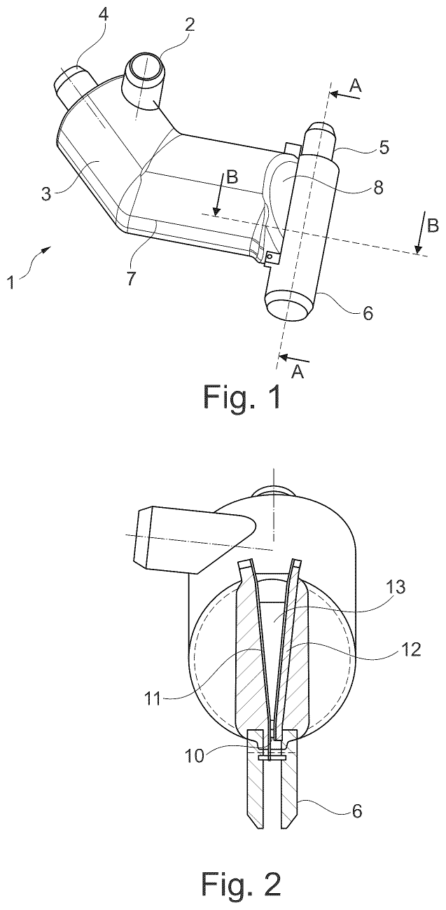

FIG. 1: shows a housing with a measuring apparatus for measuring the mass flow in a perspective view,

FIG. 2: shows a sectional view along the line A-A according to FIG. 1,

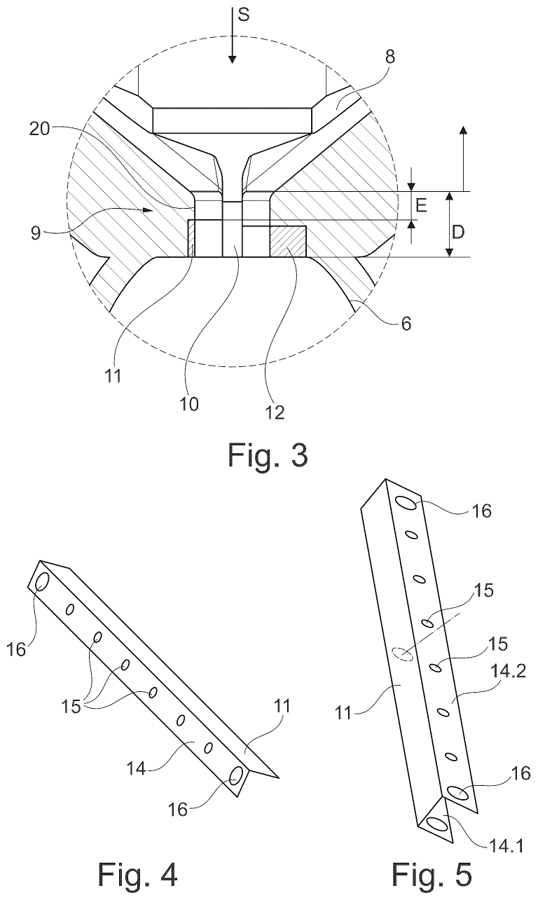

FIG. 3: shows an enlargement of a view in the section along the line B-B according to FIG. 1,

FIG. 4: shows a first exemplary embodiment of an electrode,

FIG. 5: shows a second exemplary embodiment of an electrode, and

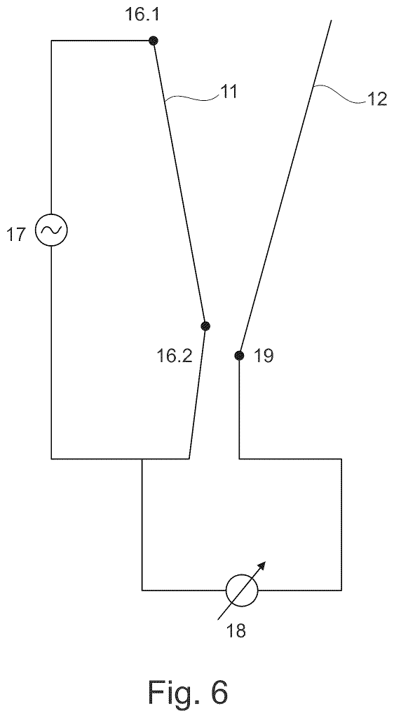

FIG. 6: shows an electric equivalent circuit of the measuring device.

The assembly according to the invention comprises a milking device and a measuring device for measuring a mass flow of milked milk. The milking device is preferably milking clusters. A milking cluster comprises the number of milking cups which is intended for an animal and connected indirectly or directly to a milk line for carrying away the milk which has been milked. The milking device as such is known in numerous embodiments.

The measuring device for measuring a mass flow of milked milk has a housing 1, which is illustrated perspectively and schematically in FIG. 1. The housing has an inlet 2. The inlet 2 is connected to a milking device, not illustrated, via a milk tube, not illustrated. The inlet 2 is arranged in such a way that the milk flow flows substantially tangentially into a housing part 3.

In the exemplary embodiment illustrated, the housing part 3 is substantially circular in cross section. The housing part 3 has a bypass nozzle 4. The bypass nozzle 4 is connected via a line, not illustrated, to a nozzle 5. The nozzle 5 is located in the area of an outlet 6. A pressure equilibrium between the inlet 2 and the outlet 6 is produced in the bypass line, not illustrated. As a result, the measuring device is kept pressure-free, so that the flow velocity of the milk is substantially independent of pressure differences. The milk which flows through the housing 1 flows because of gravity. The housing part 3 is formed in such a way that it is arranged inclined with respect to a horizontal line. The housing part 3 is adjoined by a housing part 7. This housing part 7 can also be inclined with respect to the horizontal.

A partition can also be provided within the housing 1, which is formed between the housing part 3 and the housing part 7 and extends from an upper region in the direction of a lower region. Dissipation of the flow velocity of the milk is intended to be achieved by the partition. Furthermore, improved mixing of the foam which can lie on the liquid is to be achieved.

The housing 1 has a channel which connects the inlet 2 to the outlet 6 in terms of flow. The channel is formed such that, seen in the flow direction of the milk from the inlet 2 to the outlet 6, said channel falls monotonously. This includes the inlet 2 being at a higher level than the outlet 6 in relation to a vertical. The channel can also have a portion which extends substantially horizontally.

FIG. 2 shows a sectional view along the line A-A according to FIG. 1. A first electrode 11 and a second electrode 12 can be seen from the illustration according to FIG. 2. In the exemplary embodiment illustrated, the first electrode 11 and the second electrode 12 lie in a common imaginary plane. It can be seen from the illustration according to FIG. 2 that the free flow cross section 13 between the first electrode 11 and the second electrode 12, seen from the base 10, increases toward the top, so that it is possible to speak of a V-shaped free flow cross section between the two electrodes 11 and 12.

The channel comprises a first portion and a second portion 9. The second portion 9, which, seen in the flow direction of the milk, follows a first section, has a free flow cross section which is smaller than the flow cross section of the first portion. A transition in which there is a reduction of the flow cross section from the first portion to the second portion is designated as a transition region 8.

In FIG. 3, a section illustration along the section line B-B according to FIG. 1 is shown enlarged. From this illustration, the transition region 8 can be seen. In the transition region 8, the flow cross section decreases from the first portion toward the second portion 9. A reduction in the flow cross section from the first portion to the second portion 9 in the transition region 8 preferably takes place gradually, as can be seen from FIG. 3. There is also the possibility that the cross-sectional change in the transition region 8 takes place suddenly. The flow direction of the milk is identified by the designation S, the first portion that precedes the transition region 8 not being illustrated in FIG. 3.

The second portion 9 then opens into the outlet 6. The transition region 8 is preferably formed such that the flow of the milk, that is to say the liquid phase of the milk and the foam, preferably does not break down in said transition region, so that the milk flows through the transition region 8 and flows into the second portion 9. This preferred configuration is used to prevent possible accumulation of the foam which is possibly located on the liquid phase of the milk.

The designation D identifies the length of the second portion 9 in the flow direction S. The electrodes, the first electrode 11 and the second electrode 12, are arranged within the second portion 9. In relation to a theoretical boundary between the transition region 8 and the second portion 9, the electrodes 11, 12 are arranged downstream of and at a distance from this boundary. The distance is designated by the designation E here. The electrodes 11, 12 are arranged within the second portion 9 and, seen in the flow direction S, downstream of and at a distance from the transition region 8. A region 20 of the second portion 9, which is in contact with the milk, is formed from an electrically non-conductive material. The region 20 is formed between the transition region 8 and the electrodes 11, 12. In the preferred exemplary embodiment, the region has an extent E. This region forms an electrical insulation. This measure achieves in particular the influence of standing foam upstream of the second portion 9 the measurement result being at least reduced. The housing 1 is preferably formed from an electrically non-conductive material, in particular plastic.

The electrodes 11, 12 are preferably an integral constituent part of the second portion 9.

An L-shaped electrode 11 is illustrated in FIG. 4. The electrode 11 can be a first or a second electrode in the measuring device. One leg 11 of the L-shaped electrode 11 has openings 15. Provided on the opposite ends of the leg 14 are connections 16 for connection to an electric conductor. The housing and, in particular, the second portion and, possibly, the second portion and the transition region, together form a structural unit which is produced from a plastic which is non-conductive. During the production of the second portion, plastic can flow through the openings 15, so that a secure connection between the second portion and the electrode 11 is achieved.

A further variant of an electrode is illustrated in FIG. 5. The basic principle corresponds to the configuration according to FIG. 4, the electrode being substantially U-shaped in the embodiment according to FIG. 5. The legs 14.1, 14.2 are formed with corresponding openings 15 and the connections 16.

It goes without saying that it is not absolutely necessary that the electrode has a connection 16 at its respective end, seen in the longitudinal direction. However, this has the advantage that the electric circuit which is connected to the electrodes can be placed at different locations.

An electric equivalent circuit of the measuring device according to the invention is illustrated schematically in FIG. 6.

In the exemplary embodiment illustrated in FIG. 6, a voltage source 17 is connected to the first electrode 11. The first electrode 11 has electrical connecting points 16.1, 16.2, which are at a distance from one another. A voltage measuring device 18 is connected to the second electrode 12 and to the first electrode 11. The connections 16.2, 19 of the second electrode 12 are chosen such that these are preferably at the same level. The voltage between the electrodes, the first electrode 1 and the second electrode 12, is measured by means of the voltage measuring means 18. The measured potential depends on the fill level of the milk between the two electrodes 11, 12. The electrodes 11, 12 extend as far as the base 10, so that the potential of the liquid phase of the milk is always measured there.

### LIST OF DESIGNATIONS

1 Housing
2 Inlet
3 Housing part
4 Bypass nozzle
5 Nozzle
6 Outlet
7 Housing part
8 Transition region
9 Second portion
10 Base
11 First electrode
12 Second electrode
13 Flow cross section
14, 14.1, 14.2 Leg
15 Opening
16.1, 16.2 Connection
17 Voltage source
18 Voltage measuring device 19 Connection
20 Region

1. An assembly comprising:
a milking device and a measuring device for measuring a mass flow of milked milk, wherein the measuring device has a housing with
an inlet, which is connected to the milking device,
an outlet, and
a channel connecting the inlet and the outlet,
wherein the channel has a first portion, a transition region and a second portion in the direction of the outlet,
wherein the first portion, the transition region and the second portion have a common base, which falls consistently toward the outlet,
wherein, in the transition region, the flow cross section of the first portion is reduced toward the second portion, and a measuring apparatus,
which has a first and a second electrode arranged at a distance from one another,
wherein at least one of the electrodes is arranged within the second portion and, seen in a flow direction, downstream of and at a distance from the transition region,
a voltage source, which is connected to two regions of the first electrode that are remote from one another, and
a detection apparatus, which is electrically connected to the first and the second electrode,
wherein the detection apparatus is suitable for and intended to measure a voltage potential between the first electrode and the second electrode,
wherein the second portion has a region of an electrically non-conductive material, wherein, seen in the flow direction of the milk, the region is formed upstream of the electrode.

2. The assembly as claimed in claim 1, wherein, in the transition region, the flow cross section of the first portion is reduced continuously toward the second portion.

3. The assembly as claimed in claim 1, wherein the electrodes are an integral constituent part of the second portion.

4. The assembly as claimed in claim 3, wherein at least one electrode has an L-shaped cross section.

5. The assembly as claimed in claim 3, wherein at least one electrode has a U-shaped cross section.

6. The assembly as claimed in claim 1, wherein the distance between the electrodes increases from the base in a vertical direction.
